(19) United States
(12) Patent Application Publication
(10) Pub. No.: US 2017/0207430 A1
(43) Pub. Date: Jul. 20, 2017

(54) REPAIRABLE BATTERY PACK DEVICE AND METHOD OF USE

(71) Applicant: Mean Green Products, LLC, Hamilton, OH (US)

(72) Inventor: Joseph C. Conrad, Okeana, OH (US)

(73) Assignee: Mean Green Products, LLC, Hamilton, OH (US)

(21) Appl. No.: 14/997,939

(22) Filed: Jan. 18, 2016

(51) Int. Cl. H01M 2/10; H01M 10/48; H01M 2/20; H01M 10/42

(52) U.S. Cl. CPC H01M 2/1077; H01M 10/425; H01M 10/4207; H01M 10/482; H01M 2/206; H01M 2010/4271

(57) ABSTRACT

A repairable battery pack is provided that includes a plurality of bricks, with each brick including a plurality of battery cells, a positive brick bus formed by interconnection of positive polarity tabs on the cells, a negative brick bus formed by interconnection of negative polarity tabs on the cells, at least one positive brick conductor secured to the positive brick bus, and at least one negative brick conductor secured to the negative brick bus; and a battery box wherein the bricks are positioned inside, and wherein the positive brick conductor and negative brick conductor of the plurality of bricks are connected in a series configuration, and a battery management module configured to permit or prevent the passing of input power from the bricks to an output of the battery management module.

### FIELD

The repairable battery pack device and method of use relates to battery packs, more particularly to repairable high energy density battery packs.

### BACKGROUND

Lead acid batteries have been used extensively to address small electric apparatus needs. Unfortunately, lead acid batteries have numerous disadvantages. More particularly, most lead acid battery powered lawn mowers and small electric apparatuses typically suffer from poor performance due to the heavy weight, short run times and low range caused by the lead acid batteries. In addition, they require routine maintenance and several fluids to operate, which over time, can result in a leakage of harmful fluids into the environment as well as create explosive hydrogen gas when charging. These batteries have relatively short life cycles of only 300-400 charging cycles, can only practically use about 60% of their total capacity, and rapidly decrease in voltage and power as the batteries are discharged. The amount of energy required to charge lead acid batteries is much higher per energy density, so the charging efficiency is low. These batteries cannot be easily exchanged due to large size and weight, and a multitude of complicated battery cable connections. The large area required to install these batteries creates a design issue due to an adverse center of gravity situation both laterally and vertically, which leads to undesirable steering and handling issues especially on slopes. Further, such batteries cannot be easily repaired if there is a fault within any cells of the batteries, causing the need for complete replacement of a failed battery pack.

A high energy density battery such as Lithium-ion has been introduced to address many of these issues. Unfortunately, current lithium-ion battery pack designs include numerous disadvantages. More particularly, many lithium-ion battery packs are either relatively small in size such as a cordless battery powered hand-held drill or very large such as an electric car battery pack. Other current lithium-ion batteries require external Battery Management Systems when multiple batteries are connected to each other. Such lithium-ion batteries are difficult to install, replace, or repair. Many smaller lithium-ion batteries use a large amount of lateral physical space to store a relatively low capacity due to inefficient packaging and size. Many large electric car lithium-ion battery packs are often very heavy, physically large, and not configured for small electric apparatus or to be removable except during replacement due to failure. Furthermore, neither the plurality of complicated small lithium-ion packs nor single large packs can be easily installed into and out of most small electric apparatus with ease and efficiency.

Other issues related to current lithium-ion batteries relate to their inefficient internal construction. Current lithium-ion batteries suffer from an inability to be easy to repair if any faults arise from their plurality of internal cells that accumulatively make up their total voltage, thus making the battery very difficult, dangerous, and time consuming to repair and very costly to replace. Lithium battery packs are commonly constructed by welding all connections together from all cells and bundling everything together into a pack. This makes it very difficult to distinguish and replace any of the plurality of cells in the pack. Further, when current lithium-ion batteries have internal faults, they are very difficult to diagnose as a result of the lack of an easy and efficient means of measuring individual cell voltage.

### BRIEF SUMMARY

The above considerations, and others, can addressed by the repairable battery pack device and method of use described below, which can be understood by referring to the specification, drawings, and claims. The repairable battery pack device and method of use generally relates an easy-to-repair high energy density battery pack suitable for use in small electric apparatuses, such as electric mowers, passenger/golf carts, material handling equipment, snow blowers, fertilizers, wood splitters, etc., although the repairable battery pack device and method of use described herein may in some embodiments, be utilized in other larger or smaller apparatuses suitable for use with an electric battery power source.

In at least some embodiments, the repairable battery pack device and method of use is directed to a battery pack device comprising: a plurality of bricks, each brick comprising: a plurality of battery cells, each having a positive polarity tab and a negative polarity tab, wherein the cells are secured together; a brick plate including a plurality of apertures for receiving the positive polarity tab and the negative polarity tab of each cell therethrough; a positive brick bus formed by the engagement of the positive polarity tab of each cell being engaged with the positive polarity tab of at least one adjacent cell; a negative brick bus formed by the engagement of the negative polarity tab of each cell being engaged with the negative polarity tab of at least one adjacent cell; a plurality of positive brick conductors secured to the positive brick bus; and a plurality of negative brick conductors secured to the negative brick bus; a battery box having a plurality of sides, wherein the bricks are positioned inside the battery box and adjacent to each other, and wherein the plurality of positive brick conductors and negative brick conductors of the plurality of bricks are connected in a series configuration such that a first brick of the plurality of bricks has first positive brick conductors not secured to the negative brick conductors of an adjacent brick, and a last brick of the one of the plurality of bricks has last negative brick conductors not secured to positive brick conductors of an adjacent brick; and a battery management module having an input interconnected with the last negative brick conductors, and configured to permit or prevent the passing of input power from the last negative brick conductors to a power output connector at an output of the battery management module, wherein the power output connector includes a positive output conductor interconnected with the first positive brick conductors, and a negative output conductor interconnected with the output of the battery management module.

Further, in at least some embodiments, the repairable battery pack device and method of use is directed to a battery pack device comprising: a plurality of bricks, each brick comprising: a plurality of battery cells, each having a positive polarity tab and a negative polarity tab; a positive brick bus formed by interconnection of the positive polarity tabs; a negative brick bus formed by interconnection of the negative polarity tabs; at least one positive brick conductor secured to the positive brick bus; and at least one negative brick conductor secured to the negative brick bus; a battery box having a plurality of sides, wherein the bricks are positioned inside the battery box, and wherein the positive brick conductor and negative brick conductor of the plurality of bricks are connected in a series configuration such that the positive brick conductor and negative brick conductor of each brick is interconnected, with the exception that a first brick of the plurality of bricks has a first positive brick conductor not secured to the negative brick conductor of another brick, and a last brick of the one of the plurality of bricks has a last negative brick conductor not secured to a positive brick conductor of another brick; and a battery management module having an input interconnected with at least one of the last negative brick conductor and the first positive brick conductor, and configured to permit or prevent the passing of input power from the at least one of the last negative brick conductor and the first positive brick conductor to a power output connector at an output of the battery management module.

In addition, in at least some embodiments, the repairable battery pack device and method of use is directed to a method of repairing a repairable battery pack comprising: providing a repairable battery pack having a battery box, a lid, a battery management module, and a plurality of bricks comprised of battery cells and wired together inside the box, each brick including a cell monitoring conductor, a positive conductor, and a negative, conductor, wherein one or more of the bricks is a faulty brick and the remaining bricks are non-faulty bricks; removing the battery box lid from the battery box; disconnecting, via one or more power connectors, a positive inside lid connector and a negative inside lid connector, wherein the positive inside lid connector and negative inside lid connector are interconnected with at least one of a battery management module and the bricks; disconnecting, via one or more first monitoring connectors, a positive capacity indicator conductor and a negative capacity indicator conductor from a capacity indicator secured to the lid; measuring the voltage of each of the bricks by connecting a cell monitoring device to a mating plug that is interconnected with the cell monitoring conductors; determining if the measured voltage of any one of the bricks is outside pre-determined parameters, and if outside the pre-determined parameters deem the brick to be at least one of the one or more faulty bricks; disconnecting, via one or more battery management module connectors, the battery management module; disconnecting, via one or more first positive brick connectors and first negative brick connectors, one or more first positive brick conductors and first negative brick conductors extending from the faulty brick; disconnecting, via a second monitoring connector, a second monitoring conductor extending from the faulty brick; removing the faulty brick from the battery box and install a replacement brick; connecting one or more second positive brick connectors and second negative brick connectors extending from the replacement brick to at least one of the battery management module connector and at least one of the non-faulty bricks; connecting, via a replacement monitoring connector, a replacement monitoring conductor extending from the replacement brick to the battery management module; and connecting the one or more power connectors and the one or more first monitoring connectors, and install the lid.

Additionally, the repairable battery pack device and method of use is directed for use in a small electric apparatus, wherein in case of a battery fault, the battery pack can be disassembled by removing the lid of the box, the brick voltage diagnosed by means of plugging in a digital reader, a faulty brick having a brick number can be located and replaced by disconnecting connectors between the faulty brick and other bricks in the battery pack, and connecting the cable connectors of a new brick.

### BRIEF DESCRIPTION OF THE DRAWINGS

Embodiments of the repairable battery pack device and method of use are disclosed with reference to the accompanying exemplary drawings, which are for illustrative purposes. Various portions of the device may be omitted from illustration in one or more FIGS. in order to provide a view of underlying components. The repairable battery pack device and method of use are not limited in application to the details of construction or the arrangement of the components illustrated in the drawings. The repairable battery pack device and method of use are capable of other embodiments or of being practiced or carried out in various other ways. In the drawings:

FIG. 1 is a top front perspective view of an exemplary battery pack;

FIG. 2A is a top front perspective view of an exemplary battery cell;

FIG. 2B is a top front perspective view of a plurality of battery cells situated adjacent to each other, and a brick plate;

FIG. 2C is a top front perspective view of the plurality of battery cells with the brick plate partially installed;

FIG. 2D is a top front perspective view of the plurality of battery cells with the brick plate installed;

FIG. 3A is a top front perspective view of the plurality of battery cells of FIG. 2D and a plurality of conductors secured thereto;

FIG. 3B is a top front perspective view of the plurality of battery cells of FIG. 3A with a plurality of protective panels adjacent thereto;

FIG. 3C is a top front perspective view of the plurality of battery cells of FIG. 3A with the plurality of protective panels secured to the cells and covered with a protective wrap to form an exemplary brick;

FIG. 4 is a top front perspective view of a plurality of the bricks being installed in a box of the battery pack;

FIG. 5 is a top front perspective view of the plurality of bricks installed and wired together in an exemplary series configuration;

FIG. 6 is a top front perspective view of a shelf being installed in the box over the bricks;

FIG. 7 is a top front perspective view of an exemplary module installed on the shelf;

FIG. 8 is a top front perspective view of the module interconnected with the bricks, a lid, and a cell monitoring device; and

FIG. 9 is a top front perspective view of the battery pack prior to closing the lid.

### DETAILED DESCRIPTION

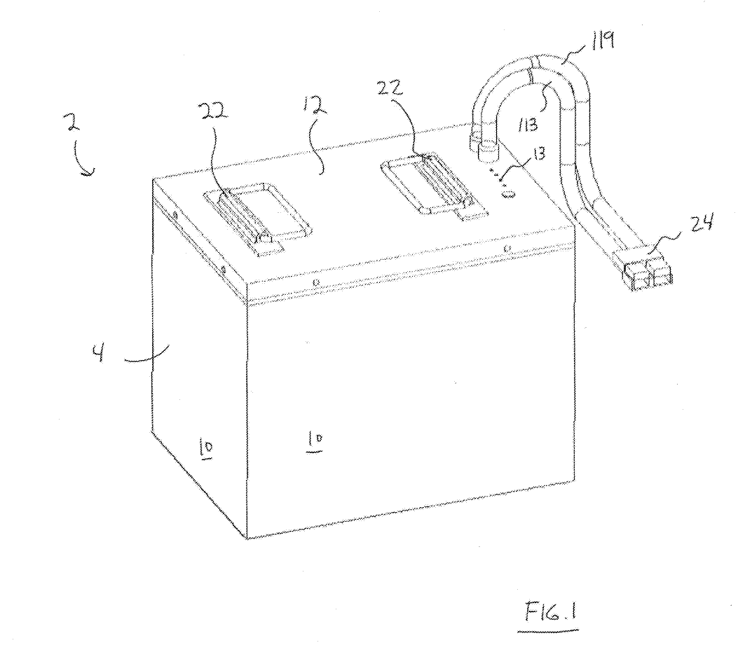

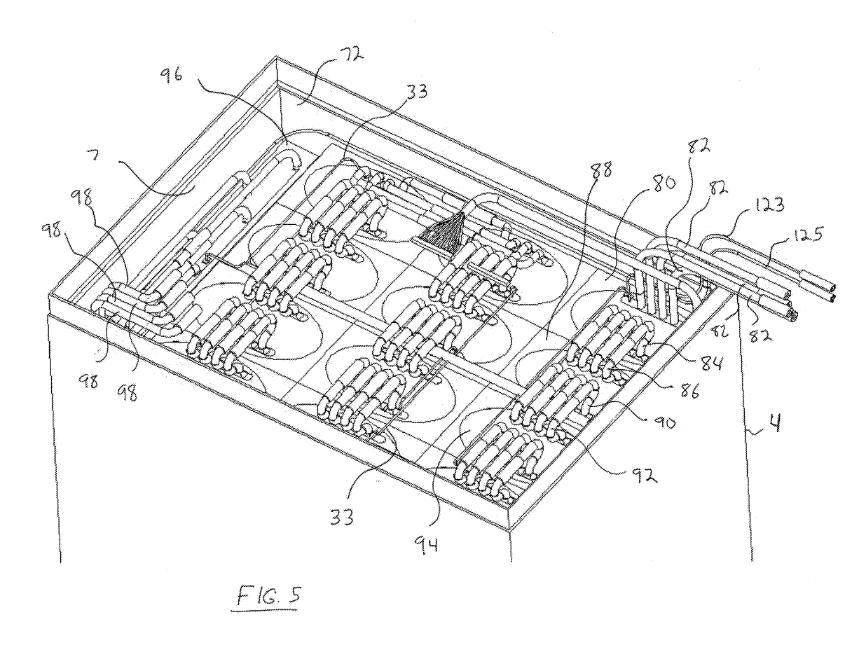

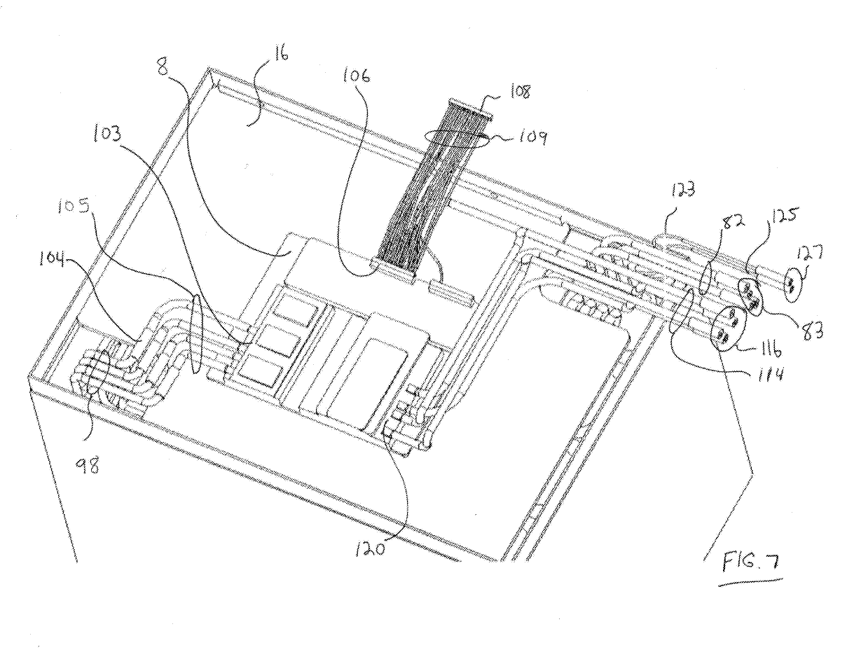

A battery pack 2 is provided by the invention as versatile and usable in numerous electrically powered apparatuses, such as an electric lawn mower, or other electrically powered devices and vehicles. Referring to FIG. 1, the exemplary battery pack 2 includes an outer structural battery box 4 that provides a protective and portable housing for a plurality of bricks and a battery management module (BMM) 8 (FIG. 7). The box 4 consists of a plurality of sides 10, a bottom (not shown), and a lid 12. The box 4 can be comprised of one or more of various materials, for example, steel, plastic, etc. In at least some embodiments, the box 4 can be waterproof when closed. In addition, the box 4 can serve as structure for which to contain or secure various other components including padding, shelves, a capacity indicator, handles 22, an external power connector 24, internal wiring, and a plurality of internal battery cells 30 (FIG. 5).

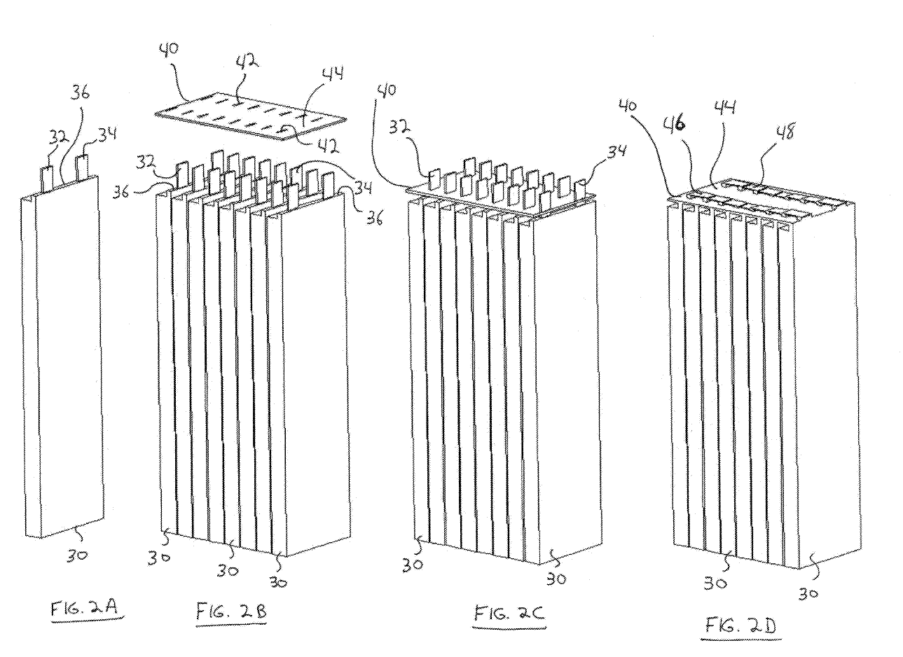

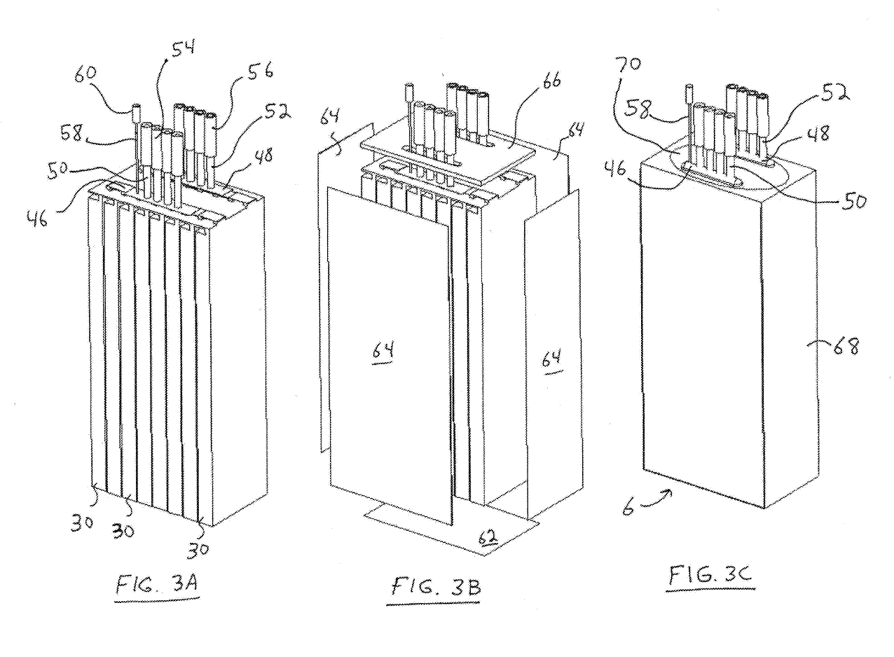

As noted above, the battery pack 2 includes a plurality of bricks 6 (FIG. 3C). Each brick 6 is comprised of a plurality of the cells 30 (FIG. 2A). In at least some embodiments, the cells 30 are lithium-based (e.g., Lithium-Ion) rated at 3.7 volts direct-current (VDC) and 14 Amp-Hours (Ah), although the cells 30 can include one or more of various types of batteries and power configurations, such as 3.2 VDC/10 Ah, 3.2 VDC/14 Ah, 3.7 VDC/14 Ah, and 3.7 VDC/10 Ah. Further, in at least some embodiments, the cells 30 are a Part No. BPHKLP1CA, as manufactured by Bestgo Power Co., Limited. The cells 30 are combined in a side-by-side arrangement to form the brick 6 of adjacent cells 30. Referring to FIG. 2A, the cells 30 each include a positive tab 32 and a negative tab 34, which can protrude from the cell upper surface 36. The tabs 32, 34 provide conductive paths for accessing the energy stored in the cell 30. The cells 30 can be secured together in a side-by-side configuration to provide a brick 6 having a plurality of cells 30. In at least some embodiments, the bricks 6 can include four cells 30 or eight cells 30, while in other embodiments, the bricks 6 can include less or more cells 30. The cells 30 can be secured together in various ways, for example shrink-wrapping.

Referring to FIGS. 2B-2D, a brick plate 40 is provided for each brick 6. In at least some embodiments, the brick plate 40 is planar and includes a plurality of apertures 42 (e.g., slots) extending therethrough, while in other embodiments the brick plate 40 can be otherwise configured. Further in some embodiments, the brick plate 40 is comprised of a substantially non-conductive material. The apertures 42 are configured to receive the tabs 32, 34 from each cell 30, which are inserted therethrough when the brick plate 40 is positioned along the cell upper surfaces 36. After all the tabs 32, 34 from each of the cells 30 in the brick 6 have been inserted and the brick plate 40 is situated along the cell upper surfaces 36, the positive tabs 32 are bent over onto each other in a row along the top surface 44 of the brick plate 40 and welded or soldered together to form a solid continuous positive brick bus 46. Likewise, the negative tabs 34 are bent over onto each other in a row along the top surface 44 of the brick plate 40 and welded or soldered together to form a solid continuous negative brick bus 48, providing a parallel connection for all the cells 30 in the brick 6.

Referring to FIGS. 3A-3C, one or more positive brick conductors 50 are conductively secured (e.g., soldered) to the positive brick bus 46, and one or more negative brick conductors 52 are conductively secured (e.g., soldered) to the negative brick bus 48. While multiple positive brick conductors 50 and multiple negative brick conductors 52 are shown, properly configured, a single positive brick conductor 50 and a single negative brick conductor 52 for each brick 6 would also likely work. Each of the conductors 50, 52 includes a mating-type connector (e.g., bullet, deans, etc.) that allows for interconnection with each other and other components without de-soldering. More particularly, the positive brick conductors 50 can include respective positive brick connectors 54 and the negative brick conductors 52 can include respective negative connectors 56. A monitoring conductor 58, having a monitoring connector 60, can be conductively secured to the positive brick bus 46 as well to provide information about the brick 6 to the BMM 8 (FIG. 7) and other components. In at least some embodiments, each brick 6 includes eight 3.7 VDC 14 Ah cells 30 having four positive brick conductors 50 and four negative brick conductors 52 extending from respective brick buses 46, 48. In such a configuration, the brick 6 will include 3.7 VDC and 112 Ah of energy from the parallel connection of eight 3.7 VDC 14 Ah cells 30. In at least some embodiments, the conductors 50, 52 are flexible wires having a solid or twisted conductor core and an insulation material covering the conductors along their length.

The brick 6 can further include a plurality of rigid panels to at least partially encase the brick 6, such as a bottom panel 62, side panels 64, and a top panel 66 with cutouts for the conductors 50, 52 to pass through. To secure the rigid plastic panels, the panels 62, 64, 66 can be temporarily secured with tape. Shrink wrap 68 is then placed around the panels and heated to allow a tight encasement of the cells 30, forming the brick 6. To further protect and secure the brick 6, a sealant, such as an epoxy 70 can be poured over and around the top panel 66 to seal the conductors 50, 52 and the monitoring conductor 58 to prevent or limit water intrusion and stress damage. The brick 6 is now complete and can then be labeled for ease of identification later. To accommodate various installations, the size and shape of the bricks 6 can vary based on the size, shape, and quantity of cells 30 utilized. For example, in at least some embodiments, a four cell brick can be formed and used in combination with another four cell brick to produce a brick that equals the size of an eight cell brick. In other embodiments, other quantities of cells 30 can be utilized to form arrangements such as a two cell or one cell brick, which can be used alone or secured to another brick.

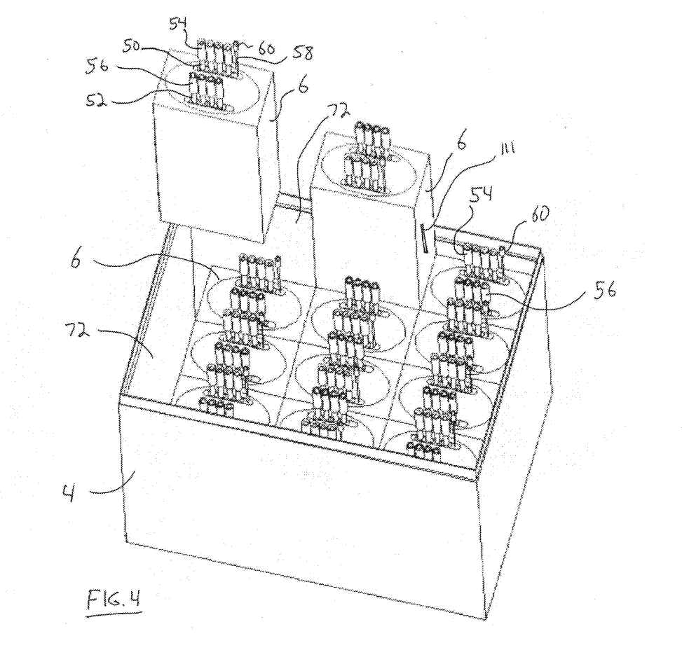

Referring to FIGS. 4 and 5, once constructed, the bricks 6 are inserted into the box 4. The bricks 6 can be positioned in numerous configurations in the box 4, for example, they can be arranged in a matrix of suitable dimensions. In addition, the bricks 6 can be shrink-wrapped together. To assist with securing and protecting the bricks 6 inside the box 4, an amount of padding material, such as foam rubber 72, can be applied to the inside of the box 4. In at least some embodiments, the bricks 6 are positioned in the box 4 in a manner that substantially aligns the positive brick conductors 50 with the negative brick conductors 52 (e.g., back-to-back). Smaller bricks, having fewer cells 30, can be positioned to best utilize the space inside the box 4, such as placing them along a side portion 76. Gaps that remain between the bricks 6 after installation can be filled with the padding material to limit or prevent free movement of the bricks 6. Once installed, the positive brick conductors 50 can be interconnected the negative brick conductors 52 via the positive brick connectors 54 and negative connectors 56. Use of the positive brick connectors 54 and negative connectors 56 can eliminate the need for cutting or soldering conductors when replacement of one of the bricks 6 is required. In addition, use of the positive brick connectors 54 and negative connectors 56, with flexible positive brick conductors 50 and negative brick conductors 52, allow for greater installation flexibility and prevent the need for fixed contacts or buses in the battery box for interconnecting the positive brick conductors 50 and negative brick conductors 52. This also can eliminate the issues related to connections issues that may occur when the battery pack 2 is subjected to turbulence.

FIG. 5 illustrates one exemplary configuration of the box 4 having a plurality of bricks 6, wherein the plurality of positive brick conductors 50 and negative brick conductors 52 are connected in a series configuration such that a first brick 80 of the plurality of bricks 6 has first positive brick conductors 82 (with first positive connectors 83) not connected to negative brick conductors 52, while first negative brick conductors 84 are connected to second positive brick conductors 86 of a second brick 88. The second brick 88 has second negative brick conductors 90 connected to third positive brick conductors 92 of a third brick 94, and so on. This series wiring continues until a last brick 96, which includes last negative brick conductors 98 that are not connected to any other positive brick connectors 54. For clarity, and by example, the last brick 96 is shown as a four cell brick, while the first brick 80, second brick 88, and third brick 94 are shown as eight cell bricks. Wiring the bricks 6 in a series configuration results in the addition of the individual voltages of the bricks 6, such that in at least some embodiments, the combined power of all the bricks 6 is 48V and 112 Ah. In at least some embodiments, the bricks 6 can be wired in a parallel configuration or a partially parallel and partially series configuration.

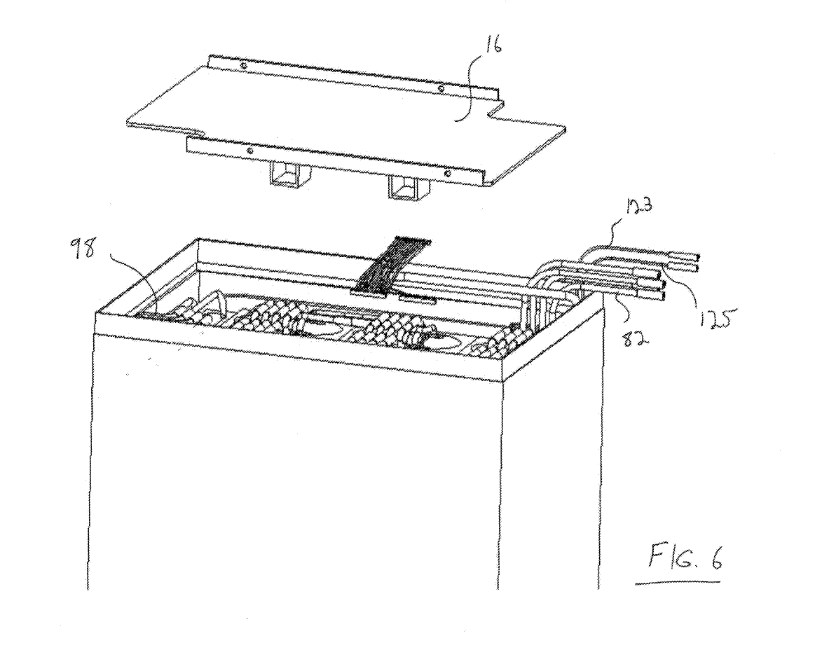

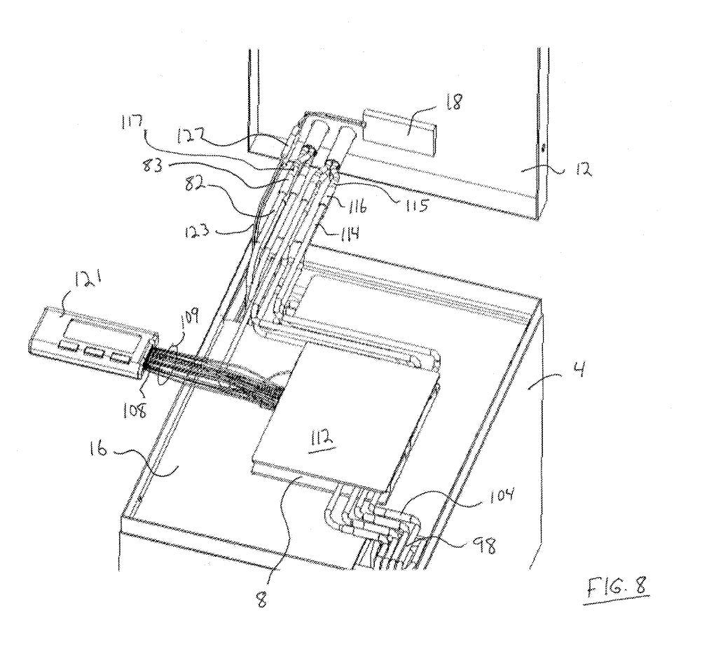

As shown in FIG. 6, once the bricks 6 have been interconnected, a shelf 16 can be installed above the bricks 6 in the box 4. In at least some embodiments, the shelf 16 has openings on opposite corners to allow for passage of the first positive brick conductors 82, the last negative brick conductors 98, and the monitoring conductors 58. Referring to FIGS. 6-8, the BMM 8 is secured to the shelf 16. The BMM 8 is configured to monitor and maintain safe operation of the battery pack 2 and provide data related to the state of the bricks 6 therein, as discussed below. As shown in FIG. 7, in at least some embodiments, the last negative brick conductors 98 are connected to a BMM input portion 103 of the BMM 8 via one or more BMM input connectors 104 (connected to the BMM input portion 103 via conductors 105). Wiring the last negative brick conductors 98 through the BMM 8 allows the BMM 8 to control the flow of power from the battery pack 2. In addition to the power connections, the monitoring conductors 58 are connected via their respective monitoring connectors 60 to a monitoring plug 106 on the BMM 8. A mating plug 108 can be provided that extends from the BMM 8, which includes parallel connections 109 from the monitoring conductors 58 on the monitoring plug 106. This mating plug 108 can be used later for diagnostics to read voltages from each cell 30 using a cell monitoring device 121 (FIG. 8).

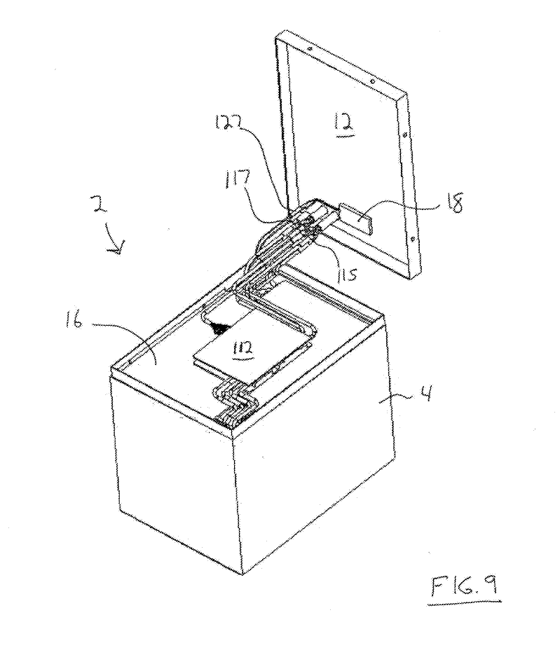

Referring to FIGS. 7-9, the BMM 8 includes a plurality of BMM output conductors 114 connected to a BMM output 120 of the BMM 8, wherein the BMM output 120 receives power passed through the BMM 8 via the BMM input portion 103. The BMM output conductors 114 are configured to be coupled directly or indirectly with various electrically powered apparatuses. In least some embodiments, the BMM output conductors 114 include BMM output connectors 116 are connected to a negative inside lid connector 115, and the first positive brick conductors 82 are connected to a positive inside lid connector 117 (FIG. 8). As can be seen in FIG. 1, the negative inside lid connector 115 and positive inside lid connector 117 extend through the lid 12 and are coupled to battery pack positive output conductor 119 and negative output conductor 113, which are connected to the external power connector 24 for connection to an electrically powered apparatus. In this manner, the lid 12 can be completely removed from the battery pack 2 without cutting wires. In at least some embodiments, the external power connector 24 is a heavy duty “push-pull”-type connector. Further, in at least some embodiments, the external power connector 24 does not extend from the lid 12. Instead, the lid 12 is configured to include a receptacle for receiving a mating plug from an electrically powered apparatus. After the shelf 12 has been installed, in at least some embodiments a protective cover, such as a rigid plastic sheet 112 (FIG. 9) is fastened over the BMM 8 to protect any open circuits from short-circuiting against the lid 12 or other surfaces prior to installing the lid 12.

One or more displays or indicators, such as the capacity indicator 18 can be connected to the bricks 6 and mounted to the lid 12 for checking the state of charge of the battery pack 2. In at least some embodiments, the capacity indicator 18 connected to a positive capacity indicator conductor 123 and a negative capacity indicator conductor 125. The positive capacity indicator conductor 123 is connected to the first positive brick conductors 82 of the first brick 80 and the negative capacity indicator conductor 125 is connected to the last negative brick conductor 98 of the last brick 96. The positive capacity indicator conductor 123 and a negative capacity indicator conductor 125 each include connectors 127. In at least some embodiments, the capacity indicator 18 includes a plurality of LEDS 13 or other indicators that are viewable through the lid 12 when the lid 12 is closed (FIG. 1). After the necessary connections have been made, the lid 12 is securely fastened to the box 4 using fasteners and the battery pack 2 can be transported by use of the handles 22 on the top of the lid 12. In at least some embodiments, the BMM 8 can include various electrical components known in the art for monitoring the charge, discharge, and functions of rechargeable batteries, such as high-density rechargeable batteries, as well as components know in the art for sensing and analyzing battery use information, such as charge state, temperature, etc. By monitoring various criteria, such as the voltage, current, discharge rate, charge rate, and cell temperature, associated with the bricks 6, the BMM 8 can identify when one or more of the bricks 6 are operating in an unsafe or faulty manner and cease power transfer from the BMM input portion 103 to the BMM output 120. Further, in at least some embodiments, the BMM 8 can include components known in the art to provide “SMART BATTERY” technology, such as a coulomb counter, that can assist with monitoring and displaying various parameters, such as watts used, watts remaining, peak current, low voltage, peak voltage, operating time from start, and charge time remaining. In at least some embodiments, the BMM 8 is configured to operatively communicate with another device, such as a Smart Charger, data logger, or other external devices using a wired or wireless connection (Bluetooth, NFC, etc.). In at least some embodiments the connection can include the use of a Controller Area Network (Can) interface.

The battery pack 2 can be charged using various types of battery chargers, including Smart Chargers that can monitor data such as temperatures and faulty cell information and stop the charging process if necessary. Regardless of the use of a Smart Charger, the BMM 8 itself can be configured to provide similar monitoring features allowing the use of non-Smart Chargers. In at least some embodiments, the BMM 8 will monitor the total voltage output of the battery pack 2, the individual voltages of each brick 6, minimum and maximum voltages of each brick 6, and the voltage difference between highest and lowest voltages of the bricks 6. Furthermore, in at least some embodiments, the BMM 8 can: monitor the temperature of the bricks 6 using a temperature sensor 111 positioned between bricks 6 and a temperature sensor on the external surface of the BMM 8; detect improper connections or short circuits; and monitor charging currents in, and discharge currents out. As discussed above, the BMM 8 can be configured to prevent operations outside the safe operating range of the battery pack 2, for example by operating an internal protection device, such as a solid state relay, to shut off delivery of battery power to the external power connector 24 when necessary.

In at least some embodiments, the battery pack 2 is suitable for use in electric apparatuses, such as an electrically driven lawn mower and is configured to be installed in an area at least the same size or smaller than two typical industry standard size side-by-side golf cart batteries (the battery pack 2 measuring about 14.5 inches long by 10.25 inches wide by 12 inches tall). Further in at least some embodiments, the battery pack 2 is rated for about 48V 112 Ah, and up to four of the 48V 112 Ah batteries in this example can be connected in parallel to form up to a 48V 448 Ah battery pack 2. Each battery pack 2 can be used for single operations or in multiples. The battery pack 2 can be configured to include numerous variations of cell 30 and brick 6 quantities, voltages, and Amp-Hour capacities.

When multiple battery packs 2 are connected to an electric apparatus in a parallel configuration, if a fault occurs in one of the battery packs 2, a voltmeter can be used to determine which battery pack 2 is faulty. At this point, the faulty battery pack can be removed and the remaining battery packs 2 can remain connected to the electric apparatus and still function with the suspect battery pack missing, as their total voltage remains substantially the same. The faulty battery pack can be diagnosed and repaired without requiring replacement. The general procedure to repair the battery pack 2 begins by identifying where in the battery pack 2 the fault occurred. First, the battery pack lid 12 is removed, and then the first positive brick conductors 82 and the BMM output conductors 114 are disconnected from their respective positive and negative inside lid connectors 115, 117. Then the positive capacity indicator conductor 123 and the negative capacity indicator conductor 125 are disconnected from the lid 12. It is now possible to check the voltage of each brick 6 by connecting a cell monitoring device 121 to the mating plug 108. In at least some embodiments, the cell monitoring device 121 is a Cellmeter-7 Digital Battery Capacity Checker, as manufactured by Tomtop Inc. After connection of the cell monitoring device 121, a repair technician can scroll through the voltages for each brick 6 to check for erroneous voltages. If one or more bricks 6 have a voltage that is outside the required specifications, they can be deemed faulty and can be replaced by, first, unplugging the BMM input connectors 104 and removing the shelf 16 with the BMM 8 still installed. The brick 6 deemed faulty can now be identified by number and the positive brick connectors 54, negative brick conductors 52, and the monitoring wire connector plug 33 for that brick 6 can be pulled apart to separate the brick deemed faulty from the bricks 6 that remain. After an additional voltage check to be sure the brick 6 deemed faulty has been located, the technician can remove the brick 6 deemed to be faulty by sliding it out of the box 4. The brick 6 that is faulty can then be set aside for proper recycling. Another brick 6 can be provided as a replacement and charged to the same voltage as the battery pack 2 is inserted back into the box 4. The positive brick connectors 54, negative brick conductors 52, and the monitoring wire connector plug 33 for the brick 6 provided as a replacement, are interconnected. The shelf 16 can now be re-installed and the BMM output conductors 114, and the first positive brick conductors 82 can be reconnected respectively to the negative inside lid connector 115 and the positive inside lid connector 117. The capacity indicator 18 is reconnected, via the positive capacity indicator conductor 123 and the negative capacity indicator conductor 125, and the lid 12 is reinstalled. The battery pack 2 can be final-tested and returned to service.

Without this time-saving easy-to-repair battery pack, the entire battery with one faulty cell would likely have been deemed unrepairable due to high labor rates and safety concerns while repairing. This entire procedure requires no specialized tools, no welding or soldering, and is particularly safe, due to no bare wires being exposed (connectors are utilized). A much less experienced technician can perform this task compared to previous high-density (e.g., lithium) batteries that require excessive soldering and exposed wire ends which can be easily short circuited during the repair process. The total cost of this repair is about 1/13 the cost of a new battery pack and much faster and safer than other known types of repairs.

It is specifically intended that the repairable battery pack and method use not be limited to the embodiments and illustrations contained herein, but include modified forms of those embodiments including portions of the embodiments and combinations of elements of different embodiments as come within the scope of the following claims. Further, the steps outlined above can be modified in various manners, such as performance in one or more alternate orders. The addition or exclusion of any step(s) discussed or not discussed, does not preclude a desired completion of the procedure. Accordingly, the foregoing description is meant to be exemplary only, the invention is to be taken as including all reasonable equivalents to the subject matter of the invention, and should not limit the scope of the invention set forth in the following claims. The use of the term plurality is intended to include one or more.

1. A battery pack device comprising:
a plurality of bricks, each brick comprising:
a plurality of battery cells, each having a positive polarity tab and a negative polarity tab, wherein the cells are secured together;
a brick plate including a plurality of apertures for receiving the positive polarity tab and the negative polarity tab of each cell therethrough;
a positive brick bus formed by the engagement of the positive polarity tab of each cell being engaged with the positive polarity tab of at least one adjacent cell;
a negative brick bus formed by the engagement of the negative polarity tab of each cell being engaged with the negative polarity tab of at least one adjacent cell;
a plurality of positive brick conductors secured to the positive brick bus; and
a plurality of negative brick conductors secured to the negative brick bus;
a battery box having a plurality of sides, wherein the bricks are positioned inside the battery box and adjacent to each other, and wherein the plurality of positive brick conductors and negative brick conductors of the plurality of bricks are connected in a series configuration such that a first brick of the plurality of bricks has first positive brick conductors not secured to the negative brick conductors of an adjacent brick, and a last brick of the one of the plurality of bricks has last negative brick conductors not secured to positive brick conductors of an adjacent brick; and
a battery management module having an input interconnected with the last negative brick conductors, and configured to permit or prevent the passing of input power from the last negative brick conductors to a power output connector at an output of the battery management module, wherein the power output connector includes a positive output conductor interconnected with the first positive brick conductors, and a negative output conductor interconnected with the output of the battery management module.

2. The device of claim 1, wherein each of the plurality of bricks includes a cell monitoring conductor, and wherein the monitoring conductors for all the bricks are interconnected with the battery management module, and wherein the battery management module is configured to prevent the passing of power from the bricks to the power output connector when a pre-determined cell malfunction is detected by the battery management module via the monitoring conductors.

3. The device of claim 1, wherein a plurality of temperature sensors are provided among the bricks, and wherein the temperature sensors are interconnected with the battery management module to prevent the passing of power received at the input of the battery management module to the output of the battery management module when a pre-determined high temperature is sensed.

4. The device of claim 1, wherein each brick includes eight or four cells.

5. The device of claim 4, wherein each battery box includes two or more bricks.

6. The device of claim 5, wherein each brick is removable from the battery box via the disengagement of connectors.

7. The device of claim 1, wherein the battery box includes a shelf for receiving and isolating the battery management module from the bricks and lid having a capacity indicator secured thereto.

8. A battery pack device comprising:
a plurality of bricks, each brick comprising:
a plurality of battery cells, each having a positive polarity tab and a negative polarity tab;
a positive brick bus formed by interconnection of the positive polarity tabs;
a negative brick bus formed by interconnection of the negative polarity tabs;
at least one positive brick conductor secured to the positive brick bus; and
at least one negative brick conductor secured to the negative brick bus;
a battery box having a plurality of sides, wherein the bricks are positioned inside the battery box, and wherein the positive brick conductor and negative brick conductor of the plurality of bricks are connected in a series configuration such that the positive brick conductor and negative brick conductor of each brick is interconnected, with the exception that a first brick of the plurality of bricks has a first positive brick conductor not secured to the negative brick conductor of another brick, and a last brick of the one of the plurality of bricks has a last negative brick conductor not secured to a positive brick conductor of another brick; and
a battery management module having an input interconnected with at least one of the last negative brick conductor and the first positive brick conductor, and configured to permit or prevent the passing of input power from the at least one of the last negative brick conductor and the first positive brick conductor to a power output connector at an output of the battery management module.

9. The device of claim 8, wherein each brick includes two or more positive brick conductors secured thereto and each negative brick conductor includes two or more negative brick conductors secured thereto.

10. The device of claim 9, further including a brick plate having a plurality of apertures for receiving the positive polarity tab and the negative polarity tab of each cell therethrough, wherein the brick plate is comprised of a non-conductive material.

11. The device of claim 8, wherein each brick includes eight 3.7 VDC 14 Ah cells connected in a parallel configuration and having four positive brick conductors and four negative brick conductors extending from respective positive and negative brick buses, providing the brick with 3.7 VDC and 112 Ah of energy.

12. The device of claim 8, wherein the positive brick conductors are not interconnected to the negative brick conductors by engagement with a structurally fixed contact secured to the battery box.

13. The device of claim 8, wherein none of the positive brick conductors and negative brick conductors are interconnected to each other by insertion of the brick into the battery box.

14. The device of claim 13, wherein at least some of the bricks are rated at 3.7 VDC and 112 Ah.

15. The device of claim 14, wherein the battery pack is 14.5 inches long by 10.25 inches wide by 12 inches tall.

16. A method of repairing a repairable battery pack comprising:
providing a repairable battery pack having a battery box, a lid, a battery management module, and a plurality of bricks comprised of battery cells and wired together inside the box, each brick including a cell monitoring conductor, a positive conductor, and a negative, conductor, wherein one or more of the bricks is a faulty brick and the remaining bricks are non-faulty bricks;
removing the battery box lid from the battery box;
disconnecting, via one or more power connectors, a positive inside lid connector and a negative inside lid connector, wherein the positive inside lid connector and negative inside lid connector are interconnected with at least one of a battery management module and the bricks;
disconnecting, via one or more first monitoring connectors, a positive capacity indicator conductor and a negative capacity indicator conductor from a capacity indicator secured to the lid;
measuring the voltage of each of the bricks by connecting a cell monitoring device to a mating plug that is interconnected with the cell monitoring conductors;
determining if the measured voltage of any one of the bricks is outside pre-determined parameters, and if outside the pre-determined parameters deem the brick to be at least one of the one or more faulty bricks;
disconnecting, via one or more battery management module connectors, the battery management module;
disconnecting, via one or more first positive brick connectors and first negative brick connectors, one or more first positive brick conductors and first negative brick conductors extending from the faulty brick;
disconnecting, via a second monitoring connector, a second monitoring conductor extending from the faulty brick;
removing the faulty brick from the battery box and install a replacement brick;
connecting one or more second positive brick connectors and second negative brick connectors extending from the replacement brick to at least one of the battery management module connector and at least one of the non-faulty bricks;
connecting, via a replacement monitoring connector, a replacement monitoring conductor extending from the replacement brick to the battery management module; and
connecting the one or more power connectors and the one or more first monitoring connectors, and install the lid.

17. The method of claim 16, wherein replacement of the faulty brick does not require cutting or soldering any conductors.

18. The method of claim 16, wherein the positive brick conductors are not interconnected to the negative brick conductors by engagement with a structurally fixed contact secured to the battery box.

19. The method of claim 16, wherein the positive brick conductors are not interconnected to other positive brick conductors by engagement with a rigid contact secured to the battery box.

20. The method of claim 16, wherein none of the positive brick conductors and negative brick conductors are interconnected to each other by insertion of a brick into the battery box.
